(19) United States
(12) Patent Application Publication
(10) Pub. No.: US 2012/0115119 A1
(43) Pub. Date: May 10, 2012

(54) Artificial Lung

(75) Inventors: Florian Lux, Berlin (DE); Peter Kadow, Berlin (DE)

(73) Assignee: MSA AUER GMBH, Berlin (DE)

(21) Appl. No.: 13/380,576

(22) PCT Filed: Jun. 25, 2010
(86) PCT No.: PCT/EP10/59057

§ 371 Date: Dec. 23, 2011

(30) Foreign Application Priority Data
Jun. 26, 2009 (DE) 10 2009 030 819.9

(51) Int. Cl. G09B 23/32

(52) U.S. Cl. 434/272

(57) ABSTRACT

The invention relates to an artificial lung for simulating the stress by a user when testing a breathing apparatus, particularly a compressed air breathing apparatus, comprising a housing, which surrounds a pulmonary space for the breathing air and has a connection for supplying the breathing air to the breathing apparatus. In order to be able to variably control the volume flow for generating a certain respiration curve, the housing (2) surrounding the pulmonary space for the breathing air is provided with an inlet (5) and with an outlet (6) for the breathing air, a fan (7, 8) is connected to the inlet and outlet (5, 6), respectively, for supplying and removing the breathing air, and a cover (13), which can be actuated by way of a drive (16) and encloses the pulmonary space (3), is disposed in the housing (2), which cover controls the volume flow of the breathing air between the inlet (5) for the breathing air and the connection (4) for the supply of the breathing air to the breathing apparatus, and/or between the connection (4) and the outlet (6) for removing the breathing air, so as to generate the breathing curve.

This invention relates to an artificial lung for simulating the stress by a user when testing a breathing apparatus, in particular a compressed air breathing apparatus, comprising a housing which surrounds a pulmonary space for the breathing air and has a connection for supplying the breathing air to the breathing port of the breathing apparatus.

Prior art artificial lungs include piston, bellows and membrane lungs.

The piston lung consists of a housing enclosing the pulmonary space with a piston and a port for supplying the breathing air to the breathing port of the breathing apparatus. The piston lung displaces air or sucks in air by changing the volume of the pulmonary space. The relation between the change in space and the air volume displaced or sucked in is linear. (“Pressureguard” of Infotec AG)

The bellows lung comes closest to the human lung. In this case, a bellows enclosing the pulmonary space is compressed and relaxed again, so that the pulmonary space is changed in its volume and breathing air can be supplied to the breathing port of the breathing apparatus and can again be discharged from the same. (“Proficheck” of MSA Auer GmbH; “Quaestor” of Draeger AG)

The membrane lung comprises a housing enclosing the pulmonary space with a piston mechanically acting on a flexible membrane. By means of the movements of the membrane the volume of the pulmonary space is changed. The membrane lung is a combination of piston and bellows lung. (“Membrane lung” of MSA Auer GmbH with all testing and approval bodies)

What is disadvantageous in all three artificial lungs, which form a closed system each with their enclosed pulmonary space, on the one hand is a large installation space for the pulmonary space and on the other hand the linear relation between change in space and volume flow displaced or sucked in.

Therefore, it is the object underlying the invention to create an artificial lung of the generic type, which only requires a small installation space for the pulmonary space and whose volume flow for generating a certain breathing curve can be controlled in a variable way.

For the solution of this object it is provided by the invention that the housing enclosing the pulmonary space for the breathing air additionally is provided with an inlet and with an outlet for the breathing air, that one blower each is connected to the inlet and to the outlet for supplying or discharging the breathing air, and that in the housing an aperture actuatable via a drive and enclosing the pulmonary space is arranged, which for generating a breathing curve controls the volume flow of the breathing air between the inlet for the breathing air and the connection for supplying the breathing air to the breathing port of the breathing apparatus or between the connection and the outlet for discharging the breathing air.

The artificial lung forms a blower lung. The principle of the blower lung is based on the generation of a volume flow of breathing air by means of at least one blower. To obtain a variable volume flow, the rotational speed of the blower can be controlled and the volume flow can be generated in dependence on the rotational speed of the blower. The faster the blower rotates, the more breathing air is moved. In technical terms, however, this solution is hardly practicable, since the masses of the moving parts in the blower are permanently accelerated and the inertia is too high to achieve a sinusoidal breathing curve with a certain period duration by means of a control.

On the other hand, with the blower lung according to the invention, which represents an open system for the breathing air, a constant volume flow is generated and limited as desired by the adjustable or rotatable aperture. The two blowers are running with a quasi constant rotational speed and the aperture is moved or rotated by means of a drive motor. To ensure that inspiration and expiration can be performed, one blower must blow in breathing air into the pulmonary space and the other blower must suck out breathing air from the pulmonary space. The design of the breathing curve is effected by a control of the angular velocity of the aperture. The maximum volume flow is determined by the performance of the blowers. By means of the variable control of the angular velocity of the aperture any breathing curve can be realized.

One advantage of the blower lung according to the invention is the small installation space for the pulmonary space. The breathing curve is not limited by the maximum lung volume of the artificial lung, but by the control of the volume flow via a variable resistor due to the dependence on overlap surfaces between the respective tube connection and the aperture opening. Thus, the installation space for the artificial lung can be designed relatively small. Another advantage consists in the possibility to integrate the testing of the functions of sucking off and blowing off into the function of the artificial lung, since a constant volume flow can be generated. As a result, no further device is required for such testing.

The artificial lung or blower lung according to the invention consists of an aperture system which can be formed as rotatable aperture or also as linear slide. The aperture system reduces the air flows of the fans or blowers arranged on the pressure and suction sides and directs the air flows to the outlet of the lung body of the blower lung. The apertures of the respective fans or blowers can be controlled individually or jointly. A complete aperture cycle simulates the breathing frequency. The aperture opening controls the breathing flow. When the aperture opening of the one blower is completely opened and the aperture opening of the other blower is closed at the same time, the maximum breathing air flow exists. The flow measurement is effected by means of a flow meter.

The aperture can either be turned rotating about 360° or oscillating about 180° C. from +90° to −90° and from −90° back to +90°. With this aperture formed as slide an oscillating forward and backward movement can be performed.

Further advantageous aspects of the artificial lung according to the invention can be taken from the sub-claims.

Advantageously, the housing is of tubular shape, whereby a small installation space becomes possible for the pulmonary space, and the aperture is formed to be rotatable in the housing.

In accordance with the invention, the inlets and outlets for the breathing air are arranged opposite each other at the tubular housing, and the aperture is formed as hollow cylinder with an aperture opening rotatable between the inlet and the outlet for the breathing air.

In a second embodiment the inlets and outlets for the breathing air according to the invention are arranged axially offset at the tubular housing, and the aperture is formed as hollow cylinder with two axially offset aperture openings rotatable between the inlet and the outlet for the breathing air.

Finally, the two blowers can be provided with a common speed-controllable drive motor.

In a third embodiment, two housings are arranged in parallel one beside the other and provided with one rotatable aperture each with one aperture opening each, and the two housings provided with the apertures are connected with each other by a housing cover with a connecting passage connecting the connections.

In further fourth to sixth embodiments, the two aperture openings in the aperture are connected with each other in a Z-shaped manner. Two Z-shaped aperture openings also can be arranged one above the other in the rotatable aperture. The two Z-shaped aperture openings also can be arranged in the aperture offset relative to each other by 90°, wherein the aperture is oscillatingly driven about 180°.

In yet a further seventh embodiment, the aperture is formed as disk with an aperture opening arranged at a radial distance to the horizontal axis of rotation, and the disk is rotatable about the horizontal axis inside a slot formed in the housing.

Finally, the aperture in the eighth embodiment is formed as slide movable to and fro in a slot in the housing and provided with two aperture openings arranged at a distance from each other, which in the respective end positions of the slide are aligned with the respective inlet or outlet of the housing.

The invention will be explained in detail below with reference to several embodiments of an artificial lung illustrated in the attached drawings, in which:

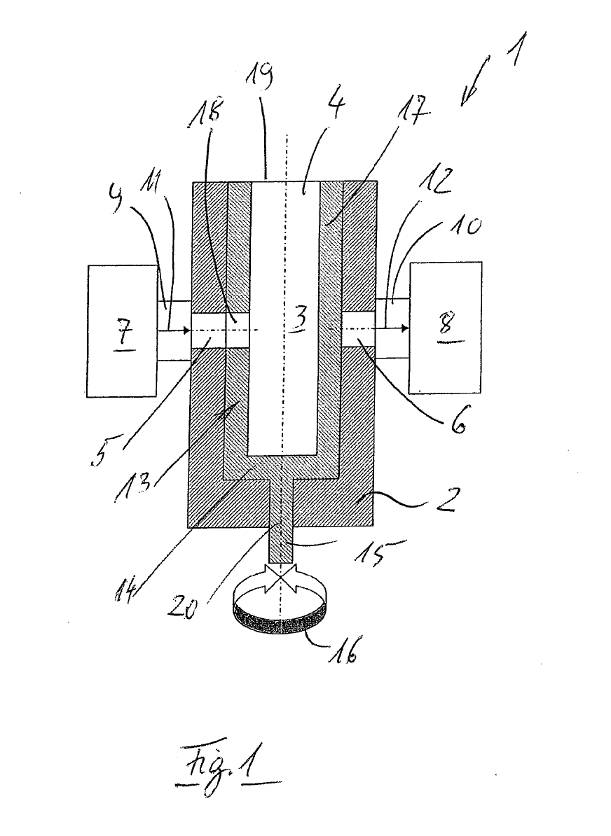

FIG. 1 shows an axial longitudinal section through the first embodiment,

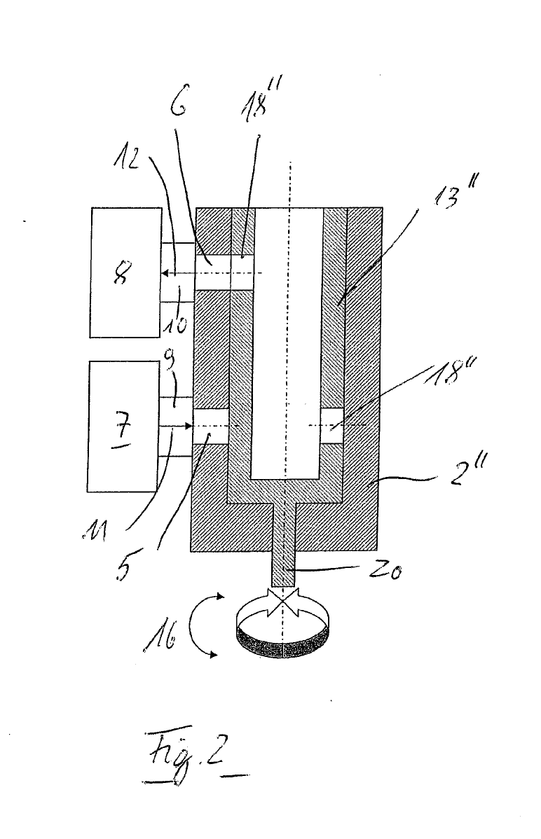

FIG. 2 shows an axial longitudinal section through the second embodiment,

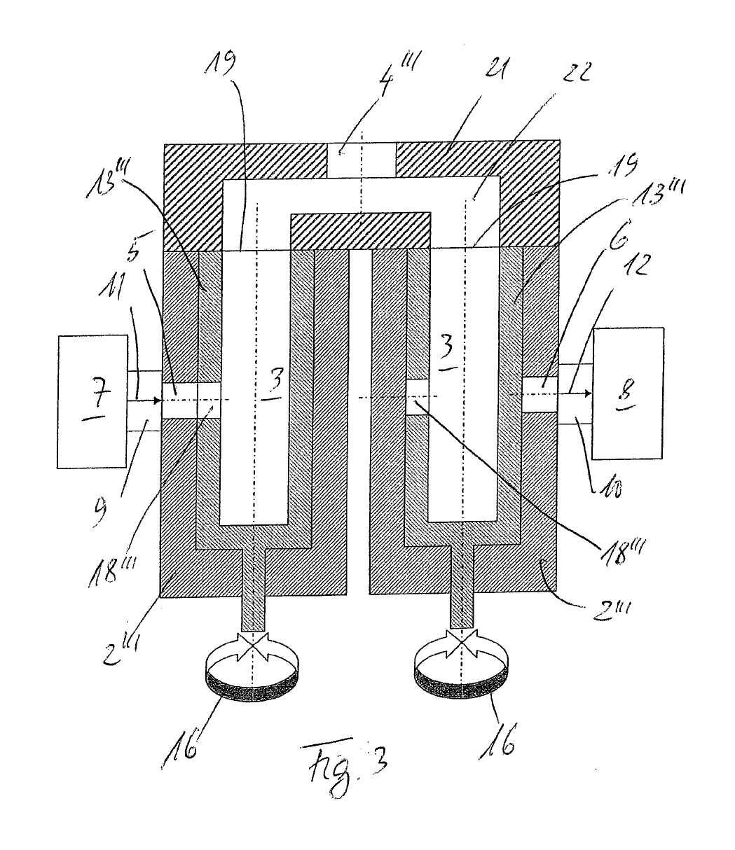

FIG. 3 shows an axial longitudinal section through the third embodiment,

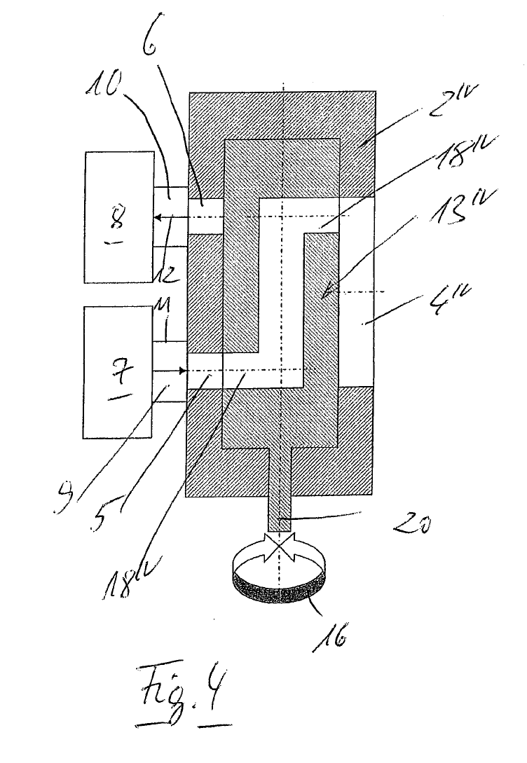

FIG. 4 shows an axial longitudinal section through the fourth embodiment,

FIG. 5 shows an axial longitudinal section through the fifth embodiment,

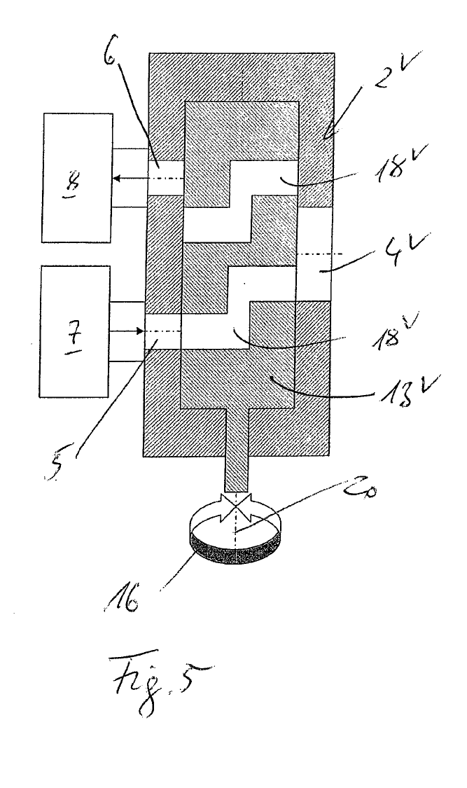

FIG. 6 shows an axial longitudinal section through the sixth embodiment,

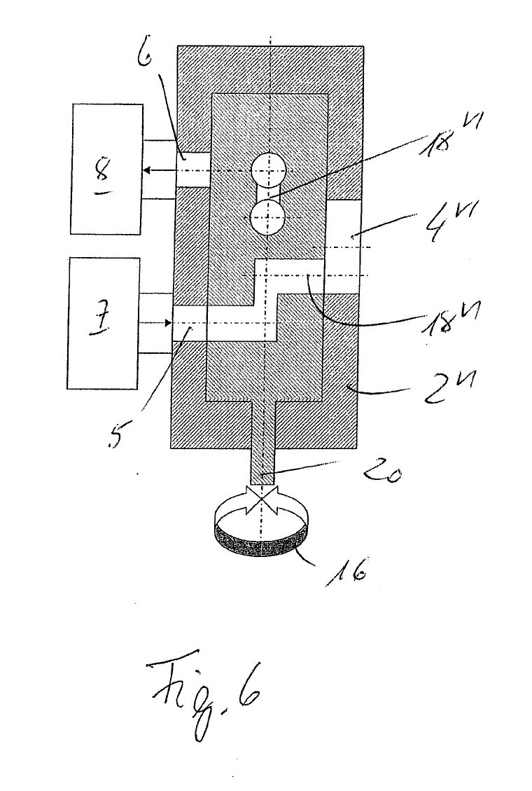

FIG. 7 shows an axial longitudinal section through the seventh embodiment,

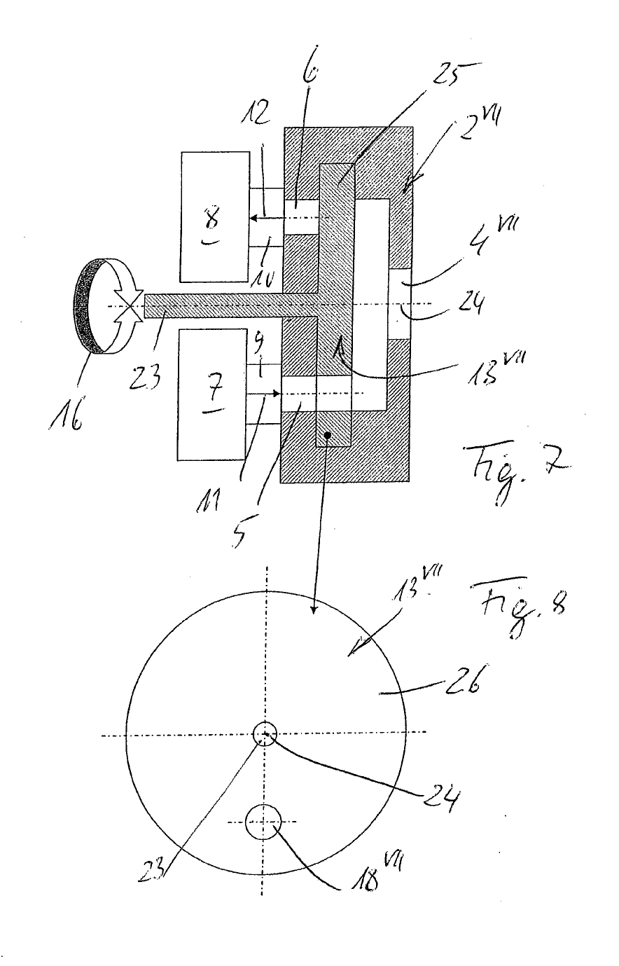

FIG. 8 shows a view of the aperture of FIG. 7,

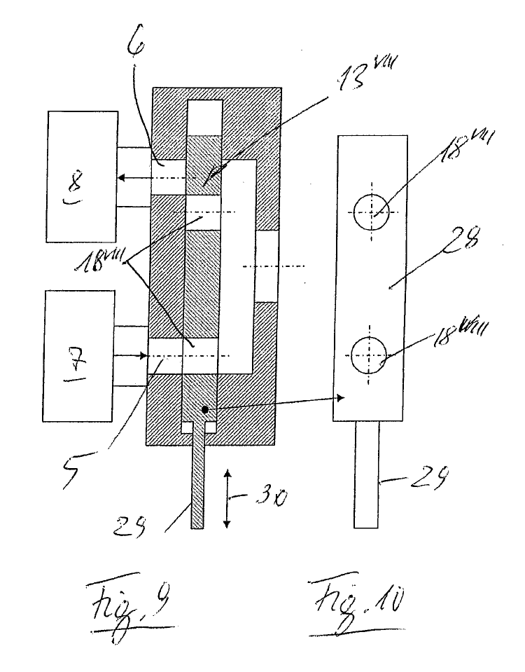

FIG. 9 shows an axial longitudinal section through the eighth embodiment, and

FIG. 10 shows a view of the aperture of FIG. 9.

The first embodiment of the artificial lung 1 as shown in FIG. 1 in an axial longitudinal section serves to simulate the stress by a user when testing a breathing apparatus, in particular a compressed air breathing apparatus.

Corresponding to the compressed air breathing apparatus to be tested set points are defined by the manufacturer for testing purposes, which must be observed to ensure that the compressed air breathing apparatus provided in particular with a regulator passes the test.

The artificial lung 1 comprises a tubular housing 2 which encloses a pulmonary space 3 for the breathing air. On the upper surface 19 the tubular housing 2 comprises a connection 4 for supplying the breathing air present in the pulmonary space 3 to the non-illustrated breathing port, in particular of the regulator of a likewise non-illustrated breathing apparatus to be tested. The housing 2 additionally is provided with an inlet 5 and with an outlet 6 for the breathing air. In the first embodiment as shown in FIG. 1, the inlet 5 and the outlet 6 are arranged opposite each other.

To the inlet 5 and to the outlet 6 of the housing 2 blowers 7, 8 are connected via tube connections 9, 10 for supplying and discharging the breathing air. For this purpose, the blower 7 is connected in blowing direction (arrow 11), and the blower 8 is connection in suction direction (arrow 12). The inlet and the outlet 5, 6 of the housing 2 are connected with the blowers 7, 8 provided with their own drives via the tube connections 9, 10.

In a concrete embodiment, the two blowers 7, 8 are formed as radial fans, are operated with an adjustable speed which is kept constant via a drive control, and provide a maximum volume flow of at least 600 l/min.

In the tubular housing 2 an aperture 13 enclosing the pulmonary space 3 is rotatably arranged, which is driven to rotate about the axle 16 (double arrow 16) via a shaft 15 adjoined to the bottom 14 of the aperture 13 and via a non-illustrated drive acting on the same. The aperture 13 is formed as a tubular hollow cylinder 17 with an aperture opening 18, which is arranged in the plane between the inlet 5 and the outlet 6 for the breathing air. The aperture 13 is arranged to be freely rotatable in the housing 2 by means of the non-illustrated drive. The interior of the hollow cylinder 17 forms the pulmonary space 3. The free, open upper surface 19 of the hollow cylinder 17 forms the connection 4 for supplying the breathing air to the breathing port of the non-illustrated breathing apparatus. The closed bottom 14 is provided with the shaft 15 leading to the non-illustrated drive. In a concrete embodiment, the drive for the aperture 13 is formed as step motor.

In the embodiment as shown in FIG. 1 the rotational speed of the two blowers 7, 8 is adjusted independent of each other, so that the maximum volume flow of both blowers 7, 8 has the same amount. This is necessary, because the two blowers 7, 8 are used in different directions of action. The blower 7 blows air (arrow 11) for expiration into the pulmonary space 3, which air is guided to the breathing port of the breathing apparatus via the connection 4. The blower 8 operates in suction direction (arrow 12) and for inspiration sucks off the air through the outlet 6 via the connection 4 of the breathing port of the breathing apparatus.

For simulating a breathing cycle, a complete rotation of the aperture about 360° is effected. In the zero position, the aperture 13 is aligned such that there is no overlap of the aperture opening 18 with the inlet and the outlet 5, 6 of the housing 2 to the blowers 7, 8 and hence there is no volume flow at the connection 4. By rotating the aperture 13 by means of the drive (double arrow 16), an overlap of the aperture opening 18 occurs with the inlet 5 of the housing 2 and with the tube connection 9 of the blow-side blower 7. The volume flow continuously increases from the angular position 0° of the aperture 13 up to the angular position 90° of the aperture 13. At the angular position 90° of the aperture 13 the overlap of the inlet 5 with the aperture opening 18 is at a maximum and the volume flow of the breathing air reaches a maximum at the connection 4 to the breathing apparatus. From the angular position 90° up to the angular position 180° the overlap and hence the volume flow again decrease continuously, until at the angular position 180° both values have dropped to zero and no more volume flow is present. The complete expiration phase proceeds at the angular position of the aperture 13 from 0° to 180°. The inspiration phase proceeds between the angular positions of 180° and 360° or 0°. By further rotating the aperture 13, an overlap of the aperture opening 18 occurs with the outlet 6 of the housing 2 and with the tube connection of the suction-side blower 8. The evacuating volume flow continuously increases from the angular position 180° of the aperture 13 up to the angular position 270° of the aperture 13. At the angular position 270° of the aperture 13 the overlap of the outlet 6 with the aperture opening 18 is at a maximum and the evacuated volume flow of the inspiration air reaches a maximum at the connection 4 of the breathing apparatus, in order to then decrease continuously to the angular position 360° and 0°, respectively.

The breathing cycle is effected by a full rotation of the aperture 13 about 360°. The breathing frequency is determined by the rotational speed of the aperture 13. The breathing volume is determined by integration of the resulting volume flow.

In the second embodiment of the artificial lung 1 as shown in FIG. 2, in contrast to the first embodiment as shown in FIG. 1, the inlet and the outlet 5, 6 for the breathing air are arranged axially offset at the tubular housing 2^{II}, wherein the inlet 5 with the pressure-side blower 7 is arranged below the outlet 6 with the suction-side blower 8. The aperture 13 is formed as hollow cylinder 17 with two axially offset aperture openings 18^{II} rotatable in the plane of the inlet 5 and in the plane of the outlet 6 for the breathing air. The function of this second embodiment corresponds to that of the first embodiment, but the expiration air only is guided through the inlet 5 to the connection 4 and the inspiration air only is guided from the connection 4 through the outlet 6.

The third embodiment of the artificial lung 1 as shown in FIG. 3 comprises two housings 2^{III} arranged one beside the other with one aperture 13^{III} each. In the housing 13^{III} shown on the left in FIG. 3 the inlet 5 is arranged, which is connected with the pressure-side blower 7 via the tube connection 9. In the housing 2^{III} shown on the right in FIG. 3 the outlet 6 is arranged, which is connected with the suction-side blower 8 via the tube connection 10. The apertures 13^{III} each provided with a pulmonary space 3 include the respective aperture openings 18^{III}, of which in the illustrated angular position the left aperture opening 18^{III} is aligned with the associated inlet 5 for generating the maximum volume flow of air, whereas the other aperture opening 18^{III} of the aperture 13^{III} shown on the right is located opposite to the wall of the housing 2^{III} and hence is closed. On their upper surfaces 19, both housings 2^{III} are connected by a connecting passage 22 bent twice and formed in a housing cover 21, which leads to the connection 4. With a synchronous rotation of both drives according to the double arrows 16, a breathing cycle is simulated similar to the above-described first embodiment as shown in FIG. 1.

In the fourth embodiment of the artificial lung 1 as shown in FIG. 4, similar to the second embodiment as shown in FIG. 2, the inlet and the outlet 5, 6 on the left side of the housing 2^{IV} are connected with the blowers 7, 8 via the tube connections 9, 10. In contrast to the first to third embodiments, the upper surface 19 is closed and the port 41V is arranged on the side of the housing 2^{IV} opposite to the inlet and the outlet 5, 6 and formed as oblong hole. At its lower end in the plane of the inlet 5, the pulmonary space 3 arranged in the vertical axis 20 is provided with a lower aperture opening 18^{IV} and at its upper end in the plane of the outlet 6 with an upper aperture opening 18¹v, which upon rotation of the aperture 13^{IV} each are oscillatingly connected with the connection 4^{IV} for supplying the breathing air to the breathing port.

As regards the formation of the housing 2^{V}, the fifth embodiment as shown in FIG. 5 corresponds to the embodiment shown in FIG. 4. In the aperture 13^{V} rotatable in the housing 2^{V}, Z-shaped aperture openings 18^{V} are formed, one of which is aligned with the inlet 5 and the connection 4^{V} and one with the outlet 6 and the connection 4^{V} in the respective rotary position, which are arranged offset by 180° relative to each other.

As regards the formation of the housing 2^{VI}, the sixth embodiment shown in FIG. 6 corresponds to the embodiments shown in FIGS. 4 and 5, and as regards the formation of the aperture 13^{VI} it corresponds to the fifth embodiment shown in FIG. 5. In contrast to this embodiment, the Z-shaped aperture openings 18^{VI} aligned with the inlet 5 and the outlet 6 in the respective rotary position only are arranged offset by 90° relative to each other. In this sixth embodiment, a breathing cycle is performed by an oscillating rotary movement of the aperture 13^{VI} about 180°.

In the seventh embodiment shown in FIGS. 7 and 8, the housing 2^{VII} substantially corresponds to the housings 2^{IV}, 2^{V} and 2^{VI} of the fourth to sixth embodiments as shown in FIGS. 4 to 6. In contrast to the apertures 13^{IV}, 13^{V} and 13^{VI} rotatable about the vertical axis 20, the aperture 13^{VII} as a disk 26 rotatable by means of a shaft 23 about a horizontal axis 24 in a slot 25 of the housing 2^{VII} is formed with an aperture opening 18^{VII} arranged at a radial distance to the axis 24, which by rotation of the disk 26 cyclically connects the inlet and the outlet 5, 6 of the housing 2^{VII} with the connection 4^{VII}.

In the eighth embodiment of the artificial lung 1 as shown in FIGS. 9 and 10 the housing 2^{VIII} is formed like in the fourth to sixth embodiments and with a slot 27 like in the seventh embodiment. In the slot 27 a slide 28 as aperture 13^{VIII} can be shifted by means of a reciprocating drive (arrow 30) acting on a trunnion 29. The slide includes two aperture openings 18^{VIII} arranged one above the other, whose distance from each other is such that in the lower position of the slide 28 as shown in FIG. 9 the inlet 5 connected with the pressure-side blower 7 is connected with the lower aperture opening 18^{VIII} and in the upper position of the slide 28 the outlet 6 connected with the suction-side blower 8 is connected with the upper aperture opening 18^{VIII}.

### LIST OF REFERENCE NUMERALS

01 artificial lung
02 housing
03 pulmonary space
04 connection
05 inlet
06 outlet
07 blower
08 blower
09 tube connection
10 tube connection
11 arrow
12 arrow
13 aperture
14 bottom
15 shaft
16 double arrow
17 hollow cylinder
18 aperture opening
19 upper surface
20 axis
21 housing cover
22 connecting passage
23 shaft
24 axis
25 slot
26 disk
27 slot
28 slide
29 trunnion
30 arrow

1. An artificial lung for simulating the stress by a user when testing a breathing apparatus, in particular a compressed air breathing apparatus, comprising a housing which surrounds a pulmonary space for the breathing air and has a connection for supplying the breathing air to the breathing port of the breathing apparatus, wherein
the housing enclosing the pulmonary space for the breathing air additionally is provided with an inlet and with an outlet for the breathing air, wherein
to the inlet and to the inlet one blower each is connected for supplying and discharging the breathing air, and wherein
in the housing an aperture actuatable via a drive, enclosing the pulmonary space and provided with at least one aperture opening is arranged, which for generating a breathing curve controls the volume flow of the breathing air between the inlet for the breathing air and the connection for supplying the breathing air to the breathing apparatus or between the connection and the outlet for discharging the breathing air.

2. The artificial lung according to claim 1, wherein the housing is tubular and the aperture is rotatable in the housing.

3. The artificial lung according to claim 2, wherein the inlet and the outlet for the breathing air are arranged opposite each other at the tubular housing and the aperture is formed as a hollow cylinder with an aperture opening rotatable between the inlet and the outlet for the breathing air.

4. The artificial lung according to claim 2, wherein the inlet and the outlet for the breathing air are arranged axially offset at the tubular housing and the aperture is formed as a hollow cylinder with two axially offset aperture openings rotatable between the inlet and the outlet for the breathing air.

5. The artificial lung according to claim 1, wherein the two blowers are provided with a common speed-controllable drive.

6. The artificial lung according to claim 1, wherein two housings are arranged one beside the other in parallel and are provided with one rotatable aperture each with one aperture opening each, and wherein the two housings provided with the apertures are connected with each other by a housing cover with a connecting passage connecting the connections.

7. The artificial lung according to claim 1, wherein the two aperture openings in the aperture are connected with each other in a Z-shaped manner.

8. The artificial lung according to claim 7, wherein two Z-shaped aperture openings are arranged one above the other in the rotatable aperture.

9. The artificial lung according to claim 8, wherein the two Z-shaped aperture openings are arranged in the aperture offset relative to each other by 90°.

10. The artificial lung according to claim 9, wherein the aperture is oscillatingly driven about 180°.

11. The artificial lung according to claim 1, wherein the aperture is formed as disk a disk with an aperture opening arranged at a radial distance to the horizontal axis, and wherein the disk is rotatable about the horizontal axis inside a slot formed in the housing.

12. The artificial lung according to claim 1, wherein the aperture is formed as a slide movable to and fro in a slot in the housing and is provided with two aperture openings arranged at a distance from each other, which in the respective end positions of the slide are aligned with the respective inlet or outlet of the housing.

13. (canceled)
